(19) United States
(12) Patent Application Publication
(10) Pub. No.: US 2009/0310896 A1
(43) Pub. Date: Dec. 17, 2009

(54) TILTING PAD JOURNAL BEARING MOUNTED WITH STEPPED SEAL TOOTH AT OIL SUPPLY PART DISPOSED BETWEEN BEARING PADS

(75) Inventors: Kyung Bo Bang, Changwon-Si (KR); Jeong Hun Kim, Changwon-Si (KR)

Correspondence Address: DUANE MORRIS LLP - Philadelphia;IP DEPARTMENT, 30 SOUTH 17TH STREET, PHILADELPHIA, PA, 19103-4196, US

(73) Assignee: Doosan Heavy Industries & Construction Co., Ltd., Changwon-Si (KR)

(21) Appl. No.: 12/194,318

(22) Filed: Aug. 19, 2008

(30) Foreign Application Priority Data
Jun. 11, 2008 (KR) 10-2008-0054812

(51) Int. Cl. F16C 17/06

(52) U.S. Cl. 384/307

(57) ABSTRACT

A tilting pad journal bearing mounted with a stepped seal tooth at an oil supply part disposed between bearing pads is disclosed. More particularly, the tilting pad journal bearing is formed by mounting a plurality of the bearing pads between an inner circumference of a bearing case and an outer circumference of a rotor, and mounting the seal tooth only to the oil supply part formed between the bearing pads to supply cooling lubricant while removing the seal tooth from a bearing pad part to thereby reduce a frictional torque between the bearing and the rotor and metal temperature, such that performance of the bearing pad can be guaranteed and the capability of the bearing can be improved by reducing loss of a driving force.

### BACKGROUND OF THE INVENTION

1. Field of the Invention

The present invention relates to a tilting pad journal bearing mounted with a stepped seal tooth at an oil supply part disposed between bearing pads, more particularly, formed by mounting a plurality of the bearing pads between an inner circumference of a bearing case and an outer circumference of a rotor, and mounting the seal tooth only to the oil supply part formed between the bearing pads to supply cooling lubricant while removing the seal tooth from a bearing pad part to thereby reduce a frictional torque between the bearing and the rotor and metal temperature, such that performance of the bearing pad can be guaranteed and the capability of the bearing can be improved by reducing loss of a driving force.

2. Description of the Related Art

Generally, as shown in FIG. 1, a conventional journal bearing is structured in such a manner that lubricant supplied through an annulus groove 7 from the outside is passed through a feed hole 8 and an orifice 5 and then supplied to a bearing pad 3.

According to rotation of a shaft, the lubricant is flown into a leading end of the bearing pad 3 and then discharged through a rear end of the bearing pad 3 moving in an axial direction.

While the lubricant is thus being discharged through the rear end of the respective bearing pads 3, temperature of the lubricant is increased.

The temperature-increased lubricant is mixed with a cooling lubricant being supplied from the orifice 5 of an oil supply part 9. Therefore, when supplied to the leading end of the bearing pad 3 next time, the lubricant has a higher temperature than the overall lubricant supplied from the oil supply part 9.

Meanwhile, the seal tooth 1 mounted to the tilting pad journal bearing is formed at both ends of the bearing casing 10 as shown in FIG. 2 and FIG. 3, thereby preventing the lubricant, which is forming an oil film, that is, the lubricant film between the rotor 2 and the bearing pad 3, from being excessively discharged in the axial direction. In addition, the seal tooth 1 helps maintain the oil film formed between the rotor 2 and the bearing pad 3 during the operation of the bearing.

Since the seal tooth 1 restricts the axial discharge of the lubricant forming the oil film of the bearing as described above, quantity of the lubricant staying in the bearing in operation is increased compared to when the seal tooth 1 is not used.

Accordingly, quantity of the lubricant flowing out from the rear end of the bearing pad 3 to the oil supply part 9 disposed between the bearing pads 3 is increased, thereby increasing temperature of the cooling lubricant flowing in a next leading end 3a of the bearing pad 3.

Here, since the temperature of the lubricant flowing in the leading end of the bearing pad 3 is a main factor determining the bearing metal temperature, the seal tooth 1 finally causes an increase of the bearing metal temperature.

Furthermore, the seal tooth 1 also increases the quantity of the lubricant staying in the bearing during the operation, accordingly increasing rotational friction between the bearing and the shaft. As a consequence, loss of a driving force for the bearing is caused.

### SUMMARY OF THE INVENTION

Therefore, the present invention has been made in view of the above problems, and it is an object of the present invention to provide a tilting pad journal bearing mounted with a stepped seal tooth at an oil supply part disposed between bearing pads, more particularly, formed by mounting a plurality of the bearing pads between an inner circumference of a bearing case and an outer circumference of a rotor, and mounting the seal tooth only to the oil supply part formed between the bearing pads to supply cooling lubricant while removing the seal tooth from a bearing pad part to thereby reduce a frictional torque between the bearing and the rotor and metal temperature, such that performance of the bearing pad can be guaranteed and the capability of the bearing can be improved by reducing loss of a driving force.

It is another object of the present invention to provide a tilting pad journal bearing mounted with a stepped seal tooth at an oil supply part disposed between bearing pads, the bearing comprising a plurality of bearing pads formed between an inner circumference of a bearing case and an outer circumference of a rotor; oil supply parts formed between the respective bearing pads to supply cooling lubricant; and seal teeth mounted to the oil supply parts.

The lubricant being heated between the rotor in operation and the bearing pads may be discharged to the outside in an axial direction of the rotor.

According to the embodiment of the present invention, the tilting pad journal bearing reduces the temperature of the lubricant flowing into a leading end of the bearing pad by restraining leakage of the cooling lubricant supplied from the outside to the oil supply part formed between the bearing pads.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional journal bearing;

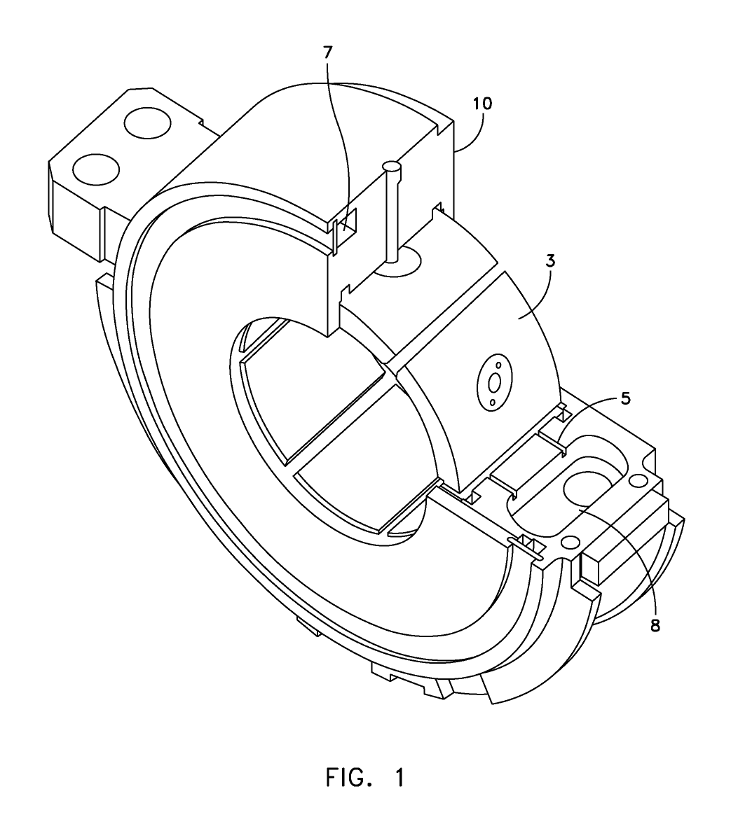

FIG. 2 is a sectional view schematically showing the conventional journal bearing;

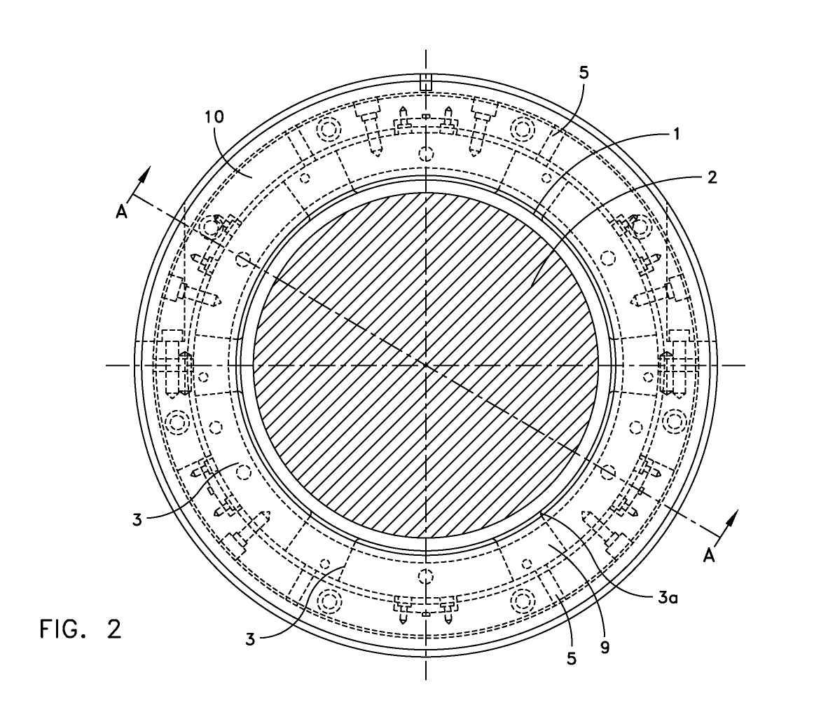

FIG. 3 is a sectional view of FIG. 2 cut along a line A-A′;

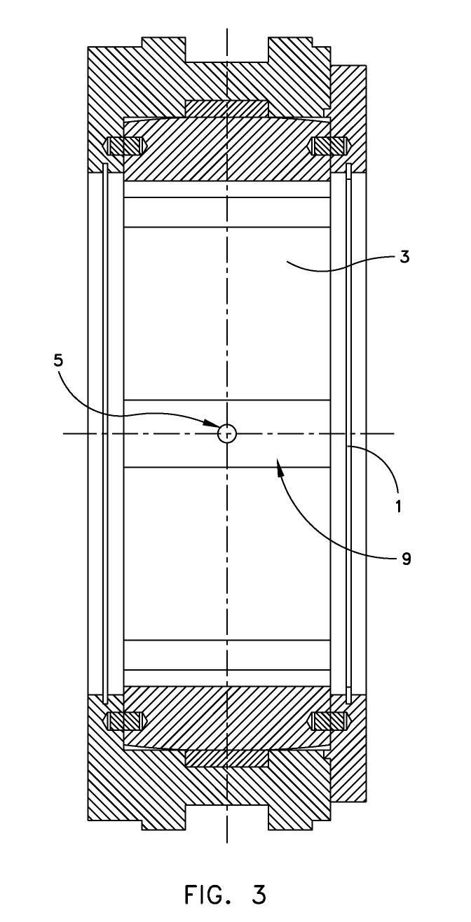

FIG. 4 is a schematic sectional view of a tilting pad journal bearing according to an embodiment of the present invention;

FIG. 5 is a sectional view of FIG. 4 cut along a line B-B′;

FIG. 6 is a schematic view showing a position for measuring the temperature of oil of a bearing pad by mounting a thermocouple to the bearing according to the embodiment of the present invention; and

FIG. 7 is a graph comparing measured oil film temperatures of the bearing pad during the operation of the bearing.

### DETAILED DESCRIPTION OF THE PREFERRED EMBODIMENTS

Hereinafter, an exemplary embodiment of the present invention will be described in detail with reference to the accompanying drawings.

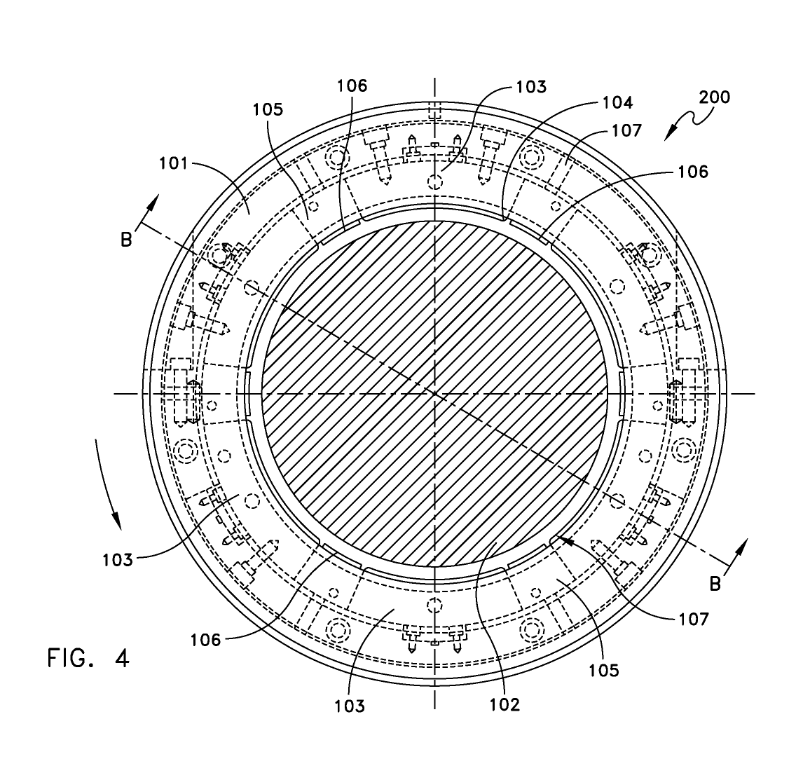

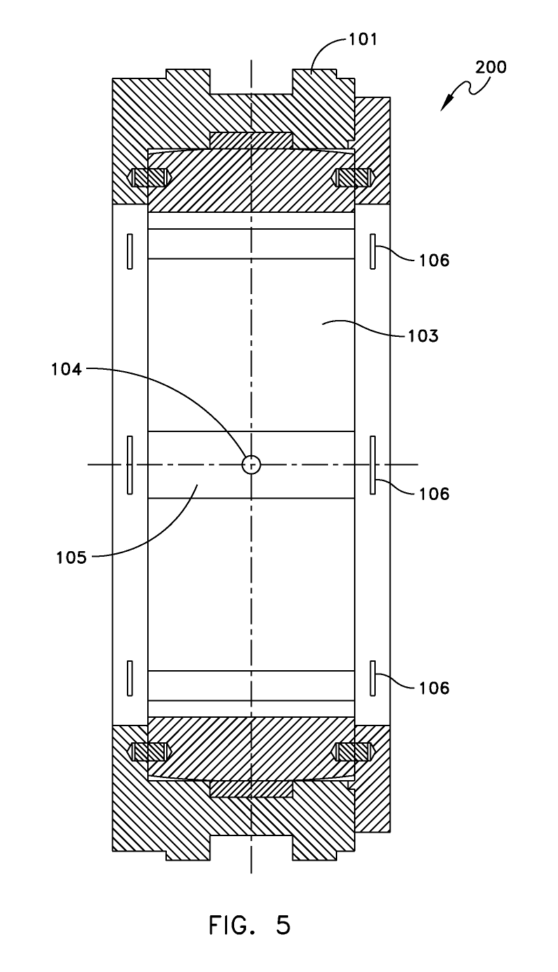

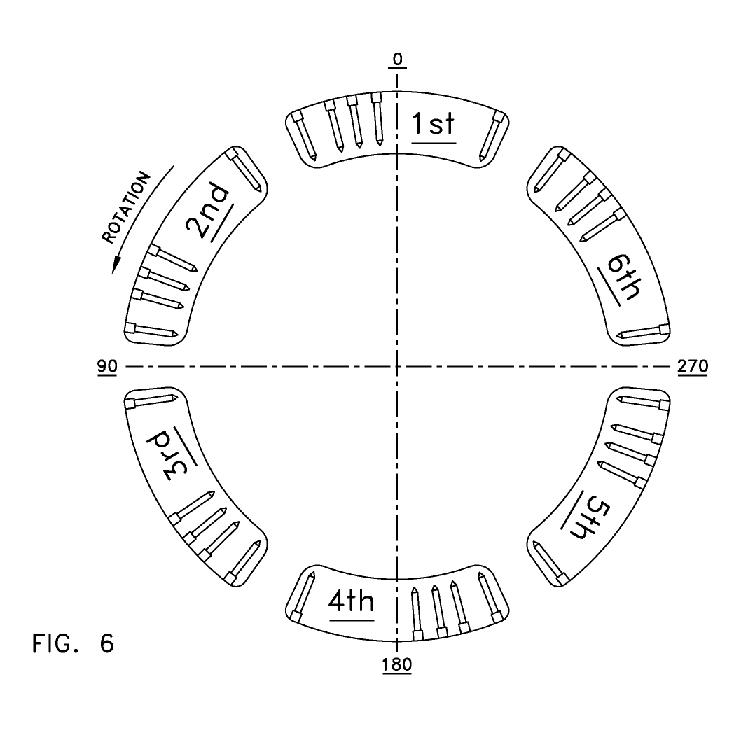

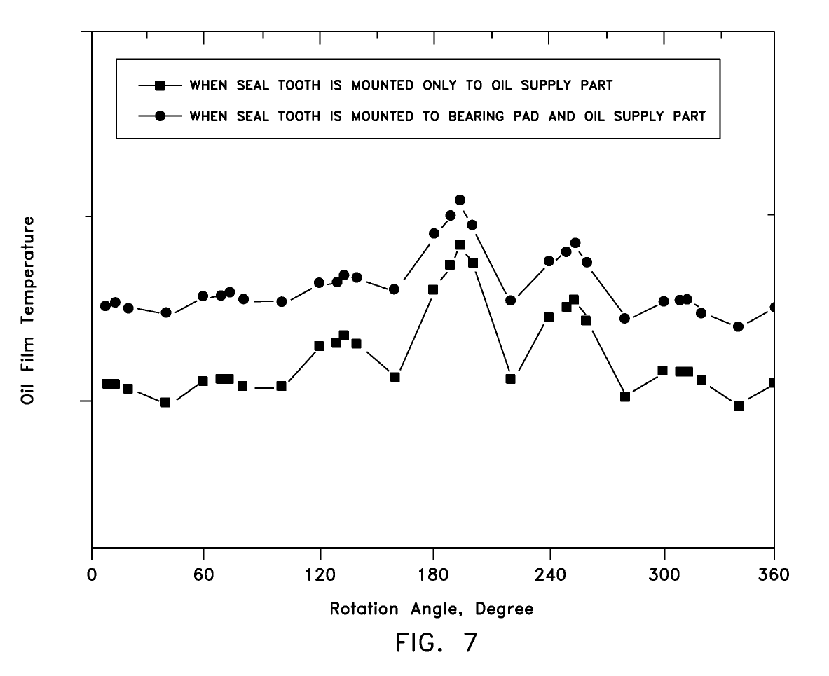

FIG. 4 is a schematic sectional view of a tilting pad journal bearing according to an embodiment of the present invention, FIG. 5 is a sectional view of FIG. 4 cut along a line B-B′, FIG. 6 is a schematic view showing a position for measuring the temperature of an oil of a bearing pad by mounting a thermocouple to the bearing according to the embodiment of the present invention, and FIG. 7 is a graph comparing measured oil film temperatures of the bearing pad during the operation of the bearing.

The tilting pad journal bearing mounted with a stepped seal tooth at an oil supply part formed between bearing pads will now be described in detail with reference to FIG. 4 to FIG. 7.

The journal bearing 200 according to the embodiment of the present invention comprises a bearing case 101, and a plurality of bearing pads 103 formed between an inner circumference of the bearing case 101 and an outer circumference of the rotor 102.

An oil supply part 105 is formed between respective two of the plurality of bearing pads 103.

In addition, an orifice 104 is provided to each oil supply part 105 to supply cooling lubricant.

Also, a stepped seal tooth 106 is mounted to each oil supply part 105.

In other words, since the seal tooth 106 is mounted only to the oil supply part 105 disposed between the bearing pads 103 but not to the bearing pads 103, the lubricant in the bearing can be discharged smoothly while friction between the bearing pad 103 and the rotor 102 can be reduced. Furthermore, accordingly, temperature of the lubricant between the bearing pad 103 and the rotor 102 is prevented from increasing.

By mounting the seal tooth 106 of a stepped structure only to the oil supply part 105 as described above, the lubricant being heated between the rotor 102 and the bearing pad 103 during rotation of the rotor 102 can be easily discharged in the axial direction of the rotor 102 as shown in FIG. 4 and FIG. 5.

The reason of discharging the heated lubricant is to reduce quantity of the lubricant staying between the rotor 102 and the bearing pad 103.

The cooling lubricant supplied from between the bearing pads 103, that is, the oil supply part 105 is supplied to a leading end 107 of the bearing pad 103, to thereby decrease the temperature of the lubricant flowing into the leading end 107.

By thus decreasing the temperature of the lubricant, that is the temperature of an oil film, between the bearing pads 103 and the rotor 102, necessity of operational suspension of the bearing owing to the increase of the lubricant temperature can be reduced. Accordingly, performance of the bearing pad 103 and the bearing is guaranteed while loss of the driving force is reduced, thereby improving the capability of the bearing.

FIG. 7 comparatively shows the temperature of the oil film formed between the rotor 102 and the bearing pad 103 when the stepped seal tooth 106 is mounted only at the oil supply part 105 of the journal bearing 200 according to the embodiment of the present invention, and the temperature of an oil film of a conventional journal bearing wherein a seal tooth is mounted between a rotor and a bearing pad.

As apparent from the above description, the present invention provides a tilting pad journal bearing mounted with a stepped seal tooth at an oil supply part disposed between bearing pads, more particularly, formed by mounting a plurality of the bearing pads between an inner circumference of a bearing case and an outer circumference of a rotor, and mounting the seal tooth only to the oil supply part formed between the bearing pads to supply cooling lubricant while removing the seal tooth from a bearing pad part to thereby reduce a frictional torque between the bearing and the rotor and metal temperature. Therefore, performance of the bearing pad can be guaranteed and the capability of the bearing can be improved by reducing loss of a driving force.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tilting pad journal bearing mounted with a stepped seal tooth at an oil supply part disposed between bearing pads, the bearing comprising:
a plurality of bearing pads formed between an inner circumference of a bearing case and an outer circumference of a rotor;
oil supply parts formed between the respective bearing pads to supply cooling lubricant; and
seal teeth mounted to the oil supply parts.

2. The tilting pad journal bearing according to claim 1, wherein the lubricant being heated between the rotor in operation and the bearing pads is discharged to the outside in an axial direction of the rotor.

3. The tilting pad journal bearing according to claim 1, which reduces the temperature of the lubricant flowing into a leading end of the bearing pad by restraining leakage of the cooling lubricant supplied from the outside to the oil supply part formed between the bearing pads.
